(19) United States
(12) Patent Application Publication
(10) Pub. No.: US 2024/0227066 A9
(43) Pub. Date: Jul. 11, 2024

(54) METHOD FOR MONITORING A LASER WELDING PROCESS, MONITORING DEVICE, AND LASER WELDING DEVICE

(71) Applicant: TRUMPF Laser GmbH, Schramberg (DE)

(72) Inventors: Jan-Patrick Hermani, Markgroeningen (DE); Martin Stambke, Dunningen (DE); Christopherg Scharfenberg, Rottenburg am Neckar (DE); Patrick Haug, Gerlingen (DE)

(21) Appl. No.: 18/402,782

(22) Filed: Jan. 3, 2024

Related U.S. Application Data
(63) Continuation of application No. PCT/EP2022/066793, filed on Jun. 21, 2022.

(30) Foreign Application Priority Data
Jul. 7, 2021 (DE) 10 2021 117 524.0

(51) Int. Cl. B23K 26/03; B23K 26/21; B23K 26/70

(52) U.S. Cl. CPC B23K 26/032; B23K 26/21; B23K 26/705

(57) ABSTRACT

A method for monitoring a laser welding process for welding workpieces by a welding laser beam is provided. The method includes, during the laser welding process, directing a measuring beam of an optical coherence tomograph onto an interaction area in which the welding laser beam interacts with the workpieces. The measuring beam penetrates the workpieces in the interaction area in a through weld of the workpieces. The measuring beam penetrating the workpieces is incident on a reference element. The method further includes acquiring measured values using the measuring beam, defining a first measured value range corresponding to detection of a material of the workpieces, defining a second measured value range corresponding to detection of the reference element, and determine a ratio of a number of measured values lying in the first measured value range and a number of measured values lying in the second measured value range.

### CROSS REFERENCE TO RELATED APPLICATIONS

This application is a continuation of International Application No. PCT/EP2022/066793 (WO 2023/280559 A1), filed on Jun. 21, 2022, and claims benefit to German Patent Application No. DE 10 2021 117 524.0, filed on Jul. 7, 2021. The aforementioned applications are hereby incorporated by reference herein.

### FIELD

Embodiments of the present invention relate to a method for monitoring a laser welding process for welding two workpieces by means of a welding laser beam, which interacts with the workpieces in an interaction area to form a weld seam.

Embodiments of the invention also relate to a monitoring device for monitoring a laser welding process for welding two workpieces by means of a welding laser beam, which interacts with the workpieces in an interaction area to form a weld seam.

Embodiments of the invention also relate to a laser welding device for carrying out a laser welding process for welding two workpieces by means of a welding laser beam, which interacts with the workpieces in an interaction area to form a weld seam.

### BACKGROUND

A method for process assessment in laser beam welding of an upper joining partner to at least one lower joining partner is known from DE 10 2019 006 282 A1, wherein items of height information in a keyhole forming due to the laser beam welding and/or in a surrounding area of the keyhole are evaluated by means of optical coherence tomography and wherein height information signals of the optical coherence tomography are evaluated, which are to be assigned to an upper side of the at least one lower joining partner.

A method for processing workpieces using laser radiation is known from EP 0 573 474 B1, in which the processing process, in particular the welding penetration depth or the degree of through welding is monitored in that optical and/or acoustic signals originating from a non-shielding, laser-induced plasma or vapor are detected and are subjected to a frequency analysis, to the result of which a predetermined computing function is applied to ascertain an assessment variable. The average amplitudes of two different frequency bands of the analyzed frequencies are used with the predetermined computing function to ascertain the assessment variable.

A processing method for a workpiece is known from US 2020/0198050 A1, wherein a process beam is directed onto the workpiece for material processing and wherein the material processing is monitored by means of an imaging beam directed onto the workpiece.

### SUMMARY

Embodiments of the present invention provide a method for monitoring a laser welding process for welding two workpieces by a welding laser beam. The welding laser beam interacts with the workpieces in an interaction area to form a weld seam. The method includes, during the laser welding process, directing a measuring beam of an optical coherence tomograph onto the interaction area. The measuring beam at least partially penetrates the workpieces in the interaction area in a through weld of the workpieces. The measuring beam penetrating the workpieces is incident on a reference element spaced apart from the workpieces. The method further includes acquiring measured values using the measuring beam, defining a first measured value range corresponding to detection of a material of the workpieces by the measuring beam in the interaction area, defining a second measured value range corresponding to detection of the reference element by the measuring beam, and evaluating the measured values acquired during the laser welding process to determine a ratio of a number of measured values lying in the first measured value range and a number of measured values lying in the second measured value range.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of an exemplary embodiment of a laser welding device for carrying out a laser welding process, which has a monitoring device for monitoring the laser welding process; and

FIG. 2 shows an example of measured values acquired by means of the monitoring device during a laser welding process, according to some embodiments.

### DETAILED DESCRIPTION

Embodiments of the invention provide a method for monitoring a laser welding process, by means of which through welds are detectable with increased reliability.

According to embodiments of the invention, in the method to monitor the laser welding process, a measuring beam of an optical coherence tomograph is directed onto the interaction area during the laser welding process to acquire measured values, wherein the measuring beam at least partially penetrates the workpieces in the interaction area in case of a through weld of the workpieces and the measuring beam penetrating the workpieces is incident on a reference element spaced apart from the workpieces, a first measured value range is defined, which is assigned to a detection of a material of the workpieces by the measuring beam in the interaction area, a second measured value range is defined, which is assigned to a detection of the reference element by the measuring beam, and measured values acquired during the laser welding process are evaluated, wherein a ratio of a number of measured values lying in the first measured value range and measured values lying in the second measured value range is formed and/or wherein a respective variance of measured values lying in the first measured value range and measured values lying in the second measured value range is ascertained.

A vapor capillary is formed during the laser welding process by means of the welding laser beam on the workpieces in the interaction area. A through weld of the workpieces can take place from a technical aspect both with open and with closed vapor capillary.

In the present case, if not indicated otherwise, a through weld is fundamentally to be understood as a through weld of the workpieces with open vapor capillary. In particular, this is to be understood as a through weld which was formed or is formed with open vapor capillary.

In particular, through welds of the workpieces with open vapor capillary may be detected by means of the method according to embodiments of the invention and/or the devices according to embodiments of the invention. In particular, an opening status of the vapor capillary may be detected and/or assessed during the formation of the weld seam.

An open vapor capillary is to be understood to mean that the vapor capillary extends through the workpieces such that the measuring beam can penetrate a combination of the workpieces to be welded, i.e., in particular it enters at a first side of the combination into the vapor capillary and at least partially exits from the vapor capillary again at a second side of the combination spaced apart from the first side.

In case of through welds with open vapor capillary during the formation of the weld seam, uniquely assignable measured values are generated by means of the reference element. It can therefore be reliably ascertained on the basis of these measured values whether through welds are present on the weld seam. In particular, a spatial density of through welds on the weld seam formed can also be reliably ascertained on the basis of these measured values. On the basis of this density of through welds on the weld seam, for example, their fluid-tightness may be assessed, wherein a higher number and/or higher density of through welds permits a higher level of fluid-tightness to be concluded. The fluid-tightness of welded bonds can be relevant, for example, in the production of fuel cells.

In particular, the method according to embodiments of the invention for detecting through welds is suitable in the laser welding process and in particular for ascertaining a spatial number and/or density of through welds on a weld seam formed.

The reference element is in particular an element independent of the workpieces and in particular independent of an arrangement and/or design of the workpieces. In particular, the reference element is not part of the workpiece and/or is not connected to the workpiece and/or is not arranged on the workpiece.

The reference element is preferably arranged and/or formed on a holding device, on which the workpieces are arranged to carry out the laser welding process.

In particular, the interaction area is to be understood as an area in which the welding laser beam is incident on the material of the workpieces when carrying out the laser welding process and/or in which an interaction of the welding laser beam with a material of the workpieces takes place, wherein the material is in particular heated and/or melted by means of the laser beam.

In particular, the workpieces consist of a material that is opaque and/or nontransparent to a wavelength of the welding laser beam. In particular, the welding laser beam is absorbed by the workpieces in the interaction area.

At least partial penetration of the workpieces by the measuring beam is to be understood in particular to mean that the measuring beam is at least partially transmitted through a combination of the workpieces to be welded.

In particular, it can be provided that the measured values acquired by means of the measuring beam are acquired and/or evaluated during the laser welding process.

It is also possible in principle that the evaluation of measured values acquired during the laser welding process takes place at a later point in time, for example after completion of the laser welding process.

It can be favorable if measured values are acquired at a frequency of at least 200 kHz and/or at most 300 kHz by means of the measuring beam of the optical coherence tomograph during the laser welding process. The weld seam may thus be monitored with a high spatial resolution and in particular may be monitored for through welds.

For the same reason, it can be advantageous if measured values are acquired at a spatial distance of at most 10.0 μm, preferably of at most 5.0 μm, and preferably of at most 3.0 μm by means of the measuring beam of the optical coherence tomograph during the laser welding process.

For example, the spatial distance is at least 1.0 μm.

In particular, it can be provided that based on the ratio of the number of measured values lying in the first measured value range and measured values lying in the second measured value range, a spatial density of through welds of the weld seam formed and/or a fluid-tightness of the weld seam formed and/or an opening status of a vapor capillary formed during the laser welding process is assessed or is assessable. The spatial number and/or density of through welds may thus be judged reliably. In particular, a fluid-tightness of the weld seam may be judged on the basis of the number or density of the through welds on the weld seam. In particular, it may be assessed based on the ratio whether the vapor capillary is open or not during formation of the weld seam and in particular how frequently the vapor capillary is open during formation of the weld seam.

A sufficient fluid-tightness can be provided, for example, if at least 10% and in particular at least 50% and in particular at least 90% of the acquired measured values lie in the second measured value range.

For the same reason, it can be favorable if based on the respective variance of the measured values lying in the first measured value range and measured values lying in the second measured value range, a spatial density of through welds of the weld seam formed and/or a fluid-tightness of the weld seam formed and/or an opening state of a vapor capillary formed during the laser welding process is assessed or is assessable. In particular, it may be assessed based on the variance whether the vapor capillary is open or not during formation of the weld seam and in particular how frequently the vapor capillary is open during formation of the weld seam.

In particular, a variance of the acquired measured values which is assigned to a detection of the reference element by the measuring beam is greater than a variance of the acquired measured values which is assigned to a detection of the material of the workpiece by the measuring beam in the interaction area.

A sufficient fluid-tightness can be provided, for example, if the variance of the measured values lying in the second measured value range is less than the variance of the measured values lying in the first measured value range.

In particular, it can be provided that the measured values used for the evaluation are acquired in a defined time interval, wherein in particular the time interval is at least 1 ms and/or at most 50 ms. Monitoring of the weld seam along a specific distance thus results.

It can be advantageous if the measuring beam is oriented parallel and/or coaxial to the welding laser beam. The measuring beam may thus be directed in a technically simple manner onto the interaction area. A measuring beam reflected on the reference element can thus be detected during the welding process in a technically simple manner.

For the same reason, it can be advantageous if the measuring beam and the welding laser beam are directed from the same direction onto the workpieces and/or are incident from the same direction on the workpieces.

For the reason mentioned, it can be advantageous if the measuring beam and the welding laser beam are incident on a first side of a combination of the workpieces to be welded.

For the same reason, it can be advantageous if the measuring beam, in case of a through weld of the workpieces, exits from a second side of the combination of the workpieces to be welded, wherein the second side is spaced apart from the first side in a beam propagation direction of the welding laser beam and/or the measuring beam.

In particular, the reference element is spaced apart from the workpieces in a beam propagation direction of the welding laser beam and/or the measuring beam and in particular is spaced apart from the second side of the combination of the workpieces to be welded.

It can be advantageous if the measuring beam penetrating the workpieces in case of a through weld is reflected on the reference element and a measuring beam reflected on the reference element is detected by means of the optical coherence tomograph. A measuring beam reflected on the reference element can thus be detected during the welding process in a technically simple manner.

For the same reason, it can be advantageous if the reflected measuring beam is directed counter to the welding laser beam, and/or if the reflected measuring beam penetrates the interaction area before its detection by the optical coherence tomograph.

In particular, it can be provided that if no through weld and/or no through weld with open vapor capillary is present, the measuring beam is reflected in the interaction area on a material of at least one of the workpieces and a measuring beam reflected on the material is detected by means of the optical coherence tomograph. In particular, the measuring beam is not reflected on the reference element when no through weld is present. In particular, measured values are then acquired in the first measured value range.

In particular, it can be provided that the laser welding process is a deep welding process, and/or a vapor capillary is formed during the laser welding process by means of the welding laser beam on the workpieces in the interaction area.

In particular, it can be provided that welding of the workpieces is carried out by means of the welding laser beam as an overlap joint and/or parallel joint.

In case of a through weld, the measuring beam penetrates the workpieces at least partially through the vapor capillary. In particular, measured values are then detected in the second measured value range.

If no through weld is present, the measuring beam cannot penetrate the workpieces at the vapor capillary. In particular, measured values in the first measured value range are then detected.

For example, a feed speed between the welding laser beam and the workpieces is at least 0.5 m/s and/or at most 1.5 m/s.

According to embodiments of the invention, a monitoring device mentioned at the outset is provided, comprising an optical coherence tomograph for providing a measuring beam for acquiring measured values during the laser welding process, wherein the measuring beam is configured so that it is directed onto the interaction area during the laser welding process and at least partially penetrates the workpieces in the interaction area in case of a through weld of the workpieces, a reference element spaced apart from the workpieces, on which the measuring beam penetrating the workpieces is incident, and an evaluation device for evaluating measured values acquired during the laser welding process, wherein by means of the evaluation device, a ratio of a number of measured values lying in a first measured value range and measured values lying in a second measured value range is formed and/or wherein by means of the evaluation device, a respective variance of measured values lying in a first measured value range and measured values lying in a second measured value range is formed, wherein the first measured value range is assigned to a detection of a material of the workpieces by the measuring beam in the interaction area and the second measured value range is assigned to a detection of the reference element by the measuring beam.

According to embodiments of the invention, a laser welding device is provided, comprising a monitoring device according to embodiments of the invention.

In particular, it can be provided that the laser welding device comprises a holding device, on which the workpieces are arrangeable or are arranged to carry out the laser welding process, wherein the reference element is arranged and/or formed on the holding device. The reference element may thus be integrated in a technically simple manner into the laser welding device and may be arranged at a defined distance from the workpieces to be welded.

For example, the holding device is or comprises a clamping device, on which the workpieces are arrangeable in a clamped manner.

In particular, the specifications “at least approximately” or “approximately” are to be understood to mean in general a deviation of at most 10%. Unless stated otherwise, the specifications “at least approximately” or “approximately” are to be understood to mean in particular that an actual value and/or distance and/or angle deviates by no more than 10% from an ideal value and/or distance and/or angle.

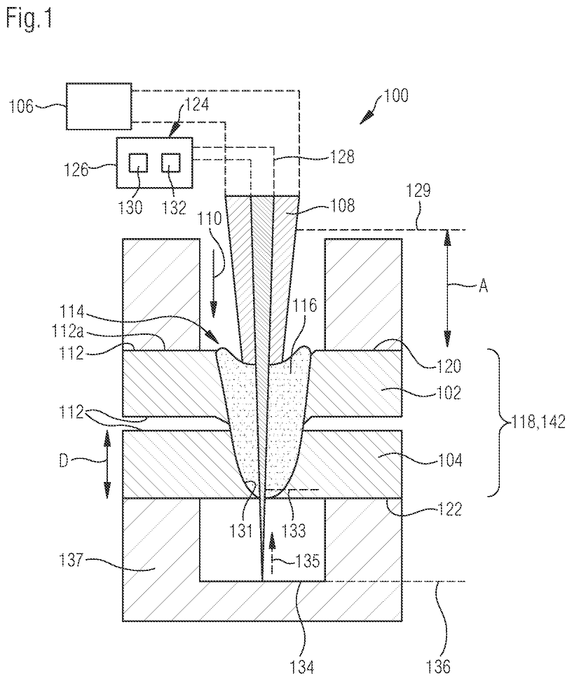

An exemplary embodiment of a laser welding device is schematically shown in FIG. 1 and is designated therein by 100. A laser welding process, in particular a deep welding process, for producing a welded bond between at least two workpieces may be carried out by means of the laser welding device 100.

In the exemplary embodiment shown in FIG. 1, it is provided that a welded bond is produced between a first workpiece 102 and a second workpiece 104 by means of the laser welding device 100.

The workpieces 102, 104 to be welded are in particular plate-shaped and/or panel-shaped.

For example, the workpieces 102, 104 consist of a metallic material and/or are formed as a sheet metal. The workpieces 102, 104 to be welded preferably each have a thickness D of approximately 75 μm.

The laser welding device 100 comprises a laser source 106, by means of which a welding laser beam 108 is provided to form the welded bond.

The welding laser beam 108 has, for example, a wavelength of at least 500 nm and/or at most 1100 nm. The welding laser beam preferably has a wavelength of at least 515 nm and/or at most 535 nm or of at least 1030 nm and/or at most 1070 nm.

In particular, the workpieces 102, 104 consist of a material that is opaque and/or nontransparent to the wavelength of the welding laser beam 108.

To form the welded bond between the first workpiece 102 and the second workpiece 104, in the example shown, the welding laser beam 108 is directed onto the first workpiece 102 and then moved at a feed speed relative to the first workpiece 102 and the second workpiece 104. A weld seam is thus formed between the first workpiece 102 and the second workpiece 104 along a trajectory of the welding laser beam 108.

For example, the feed speed is approximately 1.0 m/s.

The second workpiece 104 is positioned behind the first workpiece 102 and/or below the first workpiece 102 with respect to a beam propagation direction 110 of the welding laser beam 108. Welding of the workpieces 102, 104 by means of the welding laser beam 108 thus takes place as an overlap joint and/or parallel joint.

The first workpiece 102 and the second workpiece 104 each have outer sides 112, which are oriented perpendicular or approximately perpendicular to a thickness direction of the respective thickness D of the first workpiece 102 or the second workpiece 104.

The first workpiece 102 and the second workpiece 104 are in particular laid flatly against one another during the formation of the welded bond, wherein outer sides 112 of the first workpiece 102 and the second workpiece 104 opposite to one another and/or abutting one another are oriented parallel or approximately parallel to one another.

The welding laser beam 108 is preferably oriented perpendicular or approximately perpendicular to an outer side 112a of the first workpiece 102, onto which the welding laser beam 108 is directed. In particular, the welding laser beam 108 is oriented parallel or approximately parallel to the thickness direction of the first workpiece 102 and/or the second workpiece 104.

The welding laser beam 108 interacts during formation of the weld seam with the material of the first workpiece 102 and in particular also the second workpiece 104 in an interaction area 114. In the example shown, the welding laser beam 108 penetrates in this interaction area 114 through the outer side 112a of the first workpiece 102 into the first workpiece 102 and in particular also into the second workpiece 104.

In the interaction area 114, the welding laser beam 108 is in particular absorbed by the material of the first workpiece 102 and/or the second workpiece 104.

Due to the interaction of the welding laser beam 108 with the material of the workpieces 102, 104, not only is the material of the workpieces 102, 104 melted in the interaction area 114, but also vapor is generated. A vapor capillary 116 surrounded by molten material is thus formed in the interaction area, which is also designated as a keyhole. This vapor capillary 116 moves in particular with the welding laser beam 108 through the workpieces 102, 104.

To form a welded bond between the first workpiece 102 and the second workpiece 104 having sufficient fluid-tightness, it can be desirable for a through weld of the first workpiece 102 and the second workpiece 104 to take place when the laser welding process is carried out. A through weld is formed in particular when the vapor capillary 116 formed during the laser welding process completely penetrates a combination 118 of the first workpiece 102 and second workpiece 104 to be welded. In this case, this is a through weld with open vapor capillary 116.

If not stated otherwise, the term through weld refers hereinafter to a through weld which was formed or is formed with open vapor capillary 116.

In particular, the vapor capillary 116 extends in the case of a mentioned through weld from a first side 120 of the combination 118 to be welded to a second side 122 of the combination 118, wherein the second side 122 is spaced apart from the first side 120 in the beam propagation direction 110 of the welding laser beam 108.

In the example shown, the welding laser beam 108 is directed onto the first side 120 to form the welded bond, wherein the welding laser beam 108 is coupled in particular through this first side 120 into the combination 118. For example, the first side 120 is an upper side of the combination 118 with respect to the beam propagation direction 110 and the second side 122 is a lower side of the combination 118.

To monitor the laser welding process, the laser welding device 100 comprises a monitoring device 124. In particular, the weld seam formed during the laser welding process may be monitored for a sufficient number and/or density of through welds by means of the monitoring device 124.

The number or the density of through welds on the weld seam formed can be used in particular as a criterion for assessing a fluid-tightness of the weld seam. The higher the number or the density of through welds on the weld seam formed is, the higher its fluid-tightness typically is also.

In particular, the weld seam is monitored during or after its formation for a presence of through welds by means of the monitoring device 124.

The monitoring device 124 comprises an optical coherence tomograph 126, by means of which a measuring beam 128 is provided for acquiring measured values during the formation of the weld seam.

For example, a wavelength of the measuring beam 128 is at least 800 nm and/or at most 1600 nm.

In particular, items of distance information of a distance A with respect to a zero point position 129 can be acquired by means of the measuring beam 128, wherein these items of distance information can preferably be acquired one-dimensionally and/or with respect to a spatial direction. For example, the items of distance information can be acquired with respect to the beam propagation direction 110 and/or with respect to the thickness direction of the respective thickness D of the workpieces 102, 104.

The measuring beam 128 is directed onto an object and reflected thereon to acquire measured values and/or items of distance information. The reflected measuring beam is then detected by a detector element 130 of the optical coherence tomograph 126.

The monitoring device 124 in particular comprises an evaluation device 132 for evaluating and/or temporarily storing measured values acquired by means of the optical coherence tomograph 126.

In operation of the laser welding device 100, the measuring beam 128 is directed onto the interaction area 114, wherein the measuring beam 128 is preferably oriented parallel and/or coaxial to the welding laser beam 108. The measuring beam 128 is directed in the example shown onto the first side 120 of the combination 118 and/or coupled through the first side 120 into the combination 118.

In particular, a beam propagation direction of the measuring beam 128 at least approximately corresponds to the beam propagation direction 110 of the welding laser beam 108.

The vapor capillary 116 formed during the laser welding process in the interaction area 114 is open at least toward the first side 120 of the combination 118, so that the measuring beam 128 can penetrate therein.

If no through weld and/or no through weld with open vapor capillary 116 is present, the vapor capillary 116 is closed toward the second side 122. In this case, the measuring beam 128 is therefore reflected in the interaction area 114 on a material of the first workpiece 102 and/or the second workpiece 104, which is arranged in particular at a boundary 131 of the vapor capillary 116. For example, this material can be present in a solid or liquid state.

By means of the measuring beam 128, in case there is no open vapor capillary 116, measured values are generated in particular which are to be assigned to a position of the material of the workpieces 102, 104 at the boundary 131 of the vapor capillary 116 in the interaction area 114.

The material at which a reflection of the measuring beam 128 occurs in case there is no open vapor capillary 116 is in particular positioned at a lowest point 133 (indicated in FIG. 1) of the vapor capillary 116, spaced apart from the first side 120 in the beam propagation direction 110. The measured values acquired by means of the measuring beam 128 are then assigned, for example, to a welding penetration depth of the laser welding process.

In case of a through weld with open vapor capillary 116, the vapor capillary 116 is open toward the second side 122. The vapor capillary 116 then in particular extends continuously between the first side 120 and the second side 122 of the combination 118 of the workpieces 102, 104 to be welded.

In particular, the measuring beam 128 is transmitted at least partially and/or at least in some sections through the combination 118 of the workpieces 102, 104 in case of the through weld. The measuring beam 128 penetrates, for example, the vapor capillary 116 and/or the workpieces 102, 104 in the interaction area 114, so that it exits at least partially on the second side 122.

The transmitted measuring beam 128 is then incident on a reference element 134, which is assigned to the monitoring device 124 and/or is part of the monitoring device 124, and is reflected thereon. This reference element 134 is arranged at a reference position 136 and/or at a reference distance. In particular, the reference position 136 is spaced apart at the reference distance from the zero point position 129.

In particular, a reflected measuring beam 135 is formed by reflection of the measuring beam 128 on the reference element 134, which is preferably transmitted back through the vapor capillary 116 and then is detected by the detector element 130.

In case of the through weld, measured values which are to be assigned to the reference position 136 are therefore generated by means of the measuring beam 128.

The wavelength of the measuring beam 128 is selected in particular so that the measuring beam is transmitted through the vapor capillary 116 and is reflected on the material of the workpieces 102, 104, so that in particular measured values are acquired on the reference element in case of the through weld and are acquired on the material of the workpieces 102, 104 in case of no through weld and/or no through weld with open vapor capillary 116.

The laser welding device 100 comprises in particular a holding device 137, on which the first workpiece 102 and the second workpiece 104 are arranged to carry out the laser welding process. For example, the holding device 137 is or comprises a clamping device for clamping the first workpiece 102 and the second workpiece 104. For example, the first workpiece 102 and the second workpiece 104 are arranged clamped and/or are arranged braced against one another by means of the clamping device.

The reference element 134 is in particular part of the laser welding device 100 and/or the monitoring device 124. In particular, the reference element 134 is arranged and/or formed on the holding device 137.

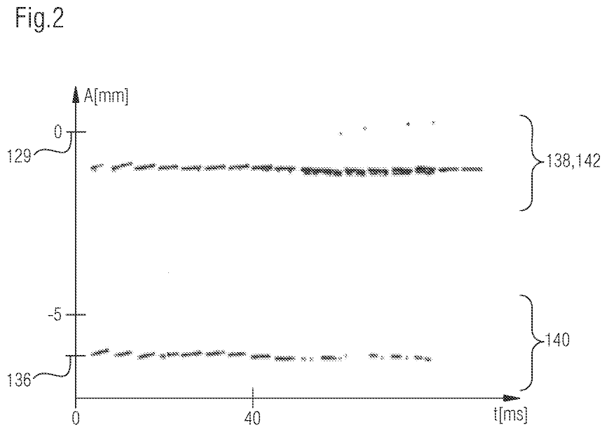

An example of measured values acquired by means of the measuring beam 128 during the formation of the weld seam as a function of time is shown in FIG. 2.

The measured values acquired while the laser welding process is carried out lie essentially (except for outliers) in a first measured value range 138, which is to be assigned to a detection of the material of the workpieces 102, 104 in the interaction area 114, and in a second measured value range 140, which is assigned to a detection of the reference element 134.

The first measured value range 138 is defined such that measured values fall therein which are to be assigned to the detection of the material of the workpieces 102, 104 in the interaction area 114. In particular, the first measured value range 138 comprises those measured values which are to be assigned to a distance range 142, in which the workpieces 102, 104 extend with respect to the beam propagation direction 110 from the zero point position 129.

The second measured value range 140 is defined such that measured values fall therein which are to be assigned to the detection of the reference element 134. In particular, the second measured value range comprises those measured values which are to be assigned to a distance of the reference position 136 from the zero point position 129.

The laser welding device 100 having the monitoring device 124 functions as follows:

The workpieces 102, 104 to be welded are arranged on the holding device 137. To form a welded bond between the workpieces 102, 104, the welding laser beam 108 generated by means of the laser source 106 is directed onto the first workpiece 102 and moved relative thereto in order to create a weld seam.

During the creation of the weld seam, the welding laser beam 108 interacts with the material of the workpieces 102, 104 in the interaction area 114, wherein a vapor capillary 116 is formed.

To monitor the laser welding process, the measuring beam 128 is directed onto the interaction area 114 during the creation of the weld seam.

If no through weld and/or no through weld with open vapor capillary 116 is present at a specific point, the measuring beam 128 will be reflected there on the material of the workpieces 102, 104, so that measured values are acquired which lie within the first measured value range 138. Then in particular no measured values are acquired which lie in the second measured value range 140.

If a through weld with open vapor capillary is present at a specific point, the measuring beam 128 will be transmitted at least at this point at least partially through the material of the workpieces 102, 104, so that measured values are acquired which lie within the second measured value range 140. With partial transmission of the measuring beam 128, it can occur in this case that two measured values are generated at this point, wherein one is to be assigned to the first measured value range 138 and one to the second measured value range 140.

The measured values acquired during the formation of the weld seam are temporarily stored and/or evaluated, for example, by means of the evaluation device 132.

To assess the weld seam with respect to a spatial density of through welds, in particular measured values are observed which were acquired within a specific time interval and/or which are assigned to a specific spatial section of the weld seam formed.

In particular, a ratio of a respective number of measured values is determined which lie in the first measured value range 138 and in the second measured value range 140 with respect to a specific time interval and/or spatial section.

A weld seam having sufficient leak-tightness and/or having a sufficient density of through welds is present in particular if at least a defined proportion, for example a proportion of at least 50%, of the observed measured values lie in the second measured value range 140.

It has been shown that those measured values which are to be assigned to a reflection of the measuring beam 128 on the material of the first workpiece 102 and/or the second workpiece 104 in the interaction area 114 typically have a greater variance and/or scattering than those measured values which are to be assigned to a reflection of the measuring beam 128 on the reference element 134.

During execution of the welding process, in particular a local position of the boundary 131 of the vapor capillary 116 varies, at which solid and/or liquid material of the workpieces 102, 104 is detected by means of the measuring beam 128. A reflection of the measuring beam 128 on the reference element 134, in contrast, always takes place at the reference position 136 of the reference element 134.

Alternatively or additionally, it can therefore be provided that the respective variance of the measured values lying in the first measured value range 138 and in the second measured value range 140 is used to assess the weld seam.

A weld seam having sufficient leak-tightness and/or having a sufficient density of through welds is present in particular if the variance of the observed measured values in the first measured value range 140 is greater than the variance of the measured values in the second measured value range 142.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

100 laser welding device
102 first workpiece
104 second workpiece
106 laser source
108 welding laser beam
110 beam propagation direction
112 outer side
112a outer side
114 interaction area
116 vapor capillary
118 combination
120 first side
122 second side
124 monitoring device
126 optical coherence tomograph
128 measuring beam
129 zero point position
130 detector element
131 boundary
132 evaluation device
133 lowest point
134 reference element
135 reflected measuring beam
136 reference position
137 holding device
138 first measured value range
140 second measured value range
142 distance range
A distance
D thickness

1. A method for monitoring a laser welding process for welding two workpieces by a welding laser beam, which interacts with the workpieces in an interaction area to form a weld seam, the method comprising:
during the laser welding process, directing a measuring beam of an optical coherence tomograph onto the interaction area, wherein the measuring beam at least partially penetrates the workpieces in the interaction area in a through weld of the workpieces, and wherein the measuring beam penetrating the workpieces is incident on a reference element spaced apart from the workpieces,
acquiring measured values using the measuring beam,
defining a first measured value range corresponding to detection of a material of the workpieces by the measuring beam in the interaction area,
defining a second measured value range corresponding to detection of the reference element by the measuring beam, and
evaluating the measured values acquired during the laser welding process to determine a ratio of a number of measured values lying in the first measured value range and a number of measured values lying in the second measured value range.

2. The method as claimed in claim 1, further comprising determining a variance of the measured values lying in the first measured value range, and a variance of the measured values lying in the second measured value range.

3. The method as claimed in claim 1, wherein the measured values at a spatial distance of at most 10.0 μm are acquired by using the measuring beam of the optical coherence tomograph during the laser welding process.

4. The method as claimed in claim 1, further comprising, based on the ratio of the number of measured values lying in the first measured value range and the number of measured values lying in the second measured value range, assessing a spatial density of the through weld of the weld seam.

5. The method as claimed in claim 1, further comprising, based on the ratio of the number of measured values lying in the first measured value range and the number of measured values lying in the second measured value range, assessing a fluid-tightness of the weld seam.

6. The method as claimed in claim 1, further comprising, based on the ratio of the number of measured values lying in the first measured value range and the number of measured values lying in the second measured value range, assessing an opening status of a vapor capillary formed during the laser welding process.

7. The method as claimed in claim 2, further comprising, based on the variance of the measured values lying in the first measured value range and the variance of the measured values lying in the second measured value range, assessing a spatial density of the through weld of the weld seam, and/or a fluid-tightness of the weld seam, and/or an opening status of a vapor capillary formed during the laser welding process.

8. The method as claimed in claim 1, wherein the measured values are acquired in a defined time interval, wherein the defined time interval is at least 1 ms and at most 50 ms.

9. The method as claimed in claim 1, wherein the measuring beam is oriented parallel and/or coaxial to the welding laser beam.

10. The method as claimed in claim 1, wherein the measuring beam and the welding laser beam are incident on a first side of a combination of the workpieces to be welded.

11. The method as claimed in claim 10, wherein the measuring beam exits from a second side of the combination of the workpieces to be welded in the through weld of the workpieces, wherein the second side is spaced apart from the first side in a beam propagation direction of the measuring beam.

12. The method as claimed in claim 1, wherein the measuring beam penetrating the workpieces in the through weld is reflected on the reference element, and the reflected measuring beam is detected by the optical coherence tomograph.

13. The method as claimed in claim 1, wherein, if no through weld and/or no through weld with open vapor capillary is present, the measuring beam is reflected in the interaction area on the material of at least one of the workpieces, and the reflected measuring beam is detected by the optical coherence tomograph.

14. A monitoring device for monitoring a laser welding process for welding two workpieces by using a welding laser beam, which interacts with the workpieces in an interaction area to form a weld seam, the monitoring device comprising:
an optical coherence tomograph for providing a measuring beam for acquiring measured values during the laser welding process, wherein the measuring beam is configured so that it is directed onto the interaction area during the laser welding process and at least partially penetrates the workpieces in the interaction area in a through weld of the workpieces,
a reference element spaced apart from the workpieces, on which the measuring beam penetrating the workpieces is incident, and
an evaluator for evaluating the measured values acquired during the laser welding process, wherein the evaluator is configured to determine a ratio of a number of measured values lying in a first measured value range and a number of measured values lying in a second measured value range, wherein the first measured value range corresponds to a detection of a material of the workpieces by the measuring beam in the interaction area, and the second measured value range corresponds to a detection of the reference element by the measuring beam.

15. The monitoring device as claimed in claim 14, wherein the evaluator is further configured to determine a variance of measured values lying in the first measured value range, and a variance of measured values lying in the second measured value range.

16. A laser welding device for carrying out a laser welding process for welding two workpieces by using a welding laser beam, which interacts with the workpieces in an interaction area to form a weld seam, the laser welding device comprising a monitoring device as claimed in claim 14.

17. The laser welding device as claimed in claim 16, further comprising a holding device, on which the workpieces are arranged to carry out the laser welding process, wherein the reference element is arranged and/or formed on the holding device.
